(19) United States
(12) Patent Application Publication
(10) Pub. No.: US 2026/0201736 A1
(43) Pub. Date: Jul. 16, 2026

(54) High Visibility Padlock Device

(71) Applicant: Robert Kelly, Edmonton (CA)

(72) Inventor: Robert Kelly, Edmonton (CA)

(21) Appl. No.: 19/021,497

(22) Filed: Jan. 15, 2025

(51) Int. Cl. E05B 67/02

(52) U.S. Cl. CPC E05B 67/02

(57) ABSTRACT

A high visibility padlock device for preventing users from losing the padlock includes a body. A shackle is coupled to the body wherein the shackle is designed to releasably secure the body to a structure. An indicium is positioned on the body. The indicium is a high visibility color wherein the indicium is designed to increase visibility of the body to a user. The high visibility color is reflective wherein the indicium is designed to reflect light to increase visibility of the body to the user. The indicium being positioned on a front wall of the body.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention.

The disclosure relates to padlocks and more particularly pertains to a new padlock for preventing users from losing the padlock.

### (2) Description of Related Art Including Information Disclosed Under 37 CFR 1.97 and 1.98.

The prior art relates to padlocks. Padlocks are commonly used in a wide variety of situations where users want to lock a door. For example, padlocks are commonly placed on gates, storage units, trailers, and sheds to maintain security over the items or other property positioned within. Trailers, and some storage units, are mobile, meaning that they are transportable between different locations. It is very important for the user to keep track of the padlock as the user is moving between locations, so that the padlock can be used in each location. However, keeping track of the padlock can be difficult, particularly because users are simultaneously trying to keep track of so many other things while they are travelling. Sheds and gates are often located in yards and other areas with high vegetative growth. These areas often do not have tabletops or other surfaces on which to place the padlock when it is not being used, creating a risk that the padlock will be dropped into the vegetative growth and lost. Therefore, there is a need in the art for a padlock device which is easy for users to see, helping to prevent them from losing the padlock when it is dropped or placed on the ground while the user is accessing the property that is secured by the padlock.

### (H) BRIEF SUMMARY OF THE INVENTION

An embodiment of the disclosure meets the needs presented above by generally comprising a body. A shackle is coupled to the body wherein the shackle is configured to releasably secure the body to a structure. An indicium is positioned on the body. The indicium is a high visibility color wherein the indicium is configured to increase visibility of the body to a user. The high visibility color is reflective wherein the indicium is configured to reflect light to increase visibility of the body to the user. The indicium being positioned on a front wall of the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom isometric view of a high visibility padlock device according to an embodiment of the disclosure.

FIG. 2 is a top isometric view of an embodiment of the disclosure.

FIG. 3 is an in-use view of an embodiment of the disclosure.

FIG. 4 is a front view of an embodiment of the disclosure.

FIG. 5 is a front view of an embodiment of the disclosure.

### (J) DETAILED DESCRIPTION OF THE INVENTION

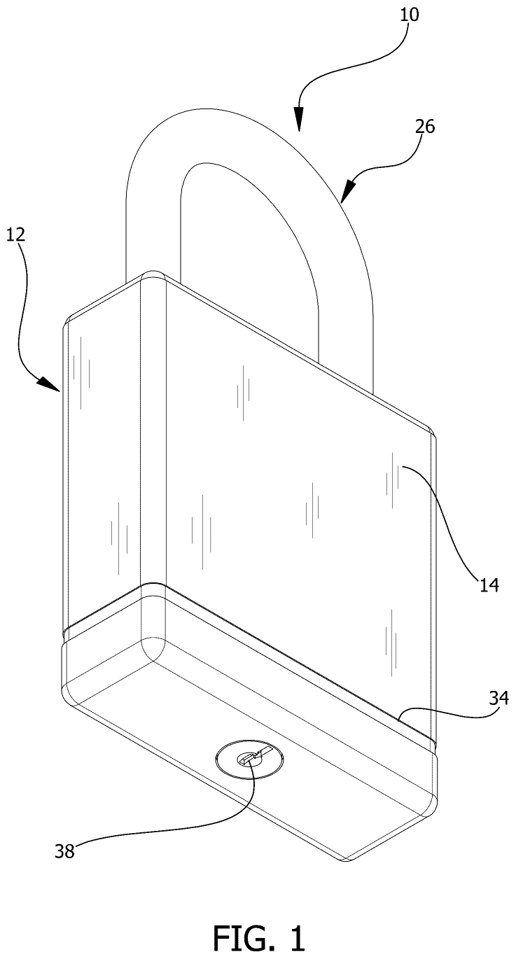

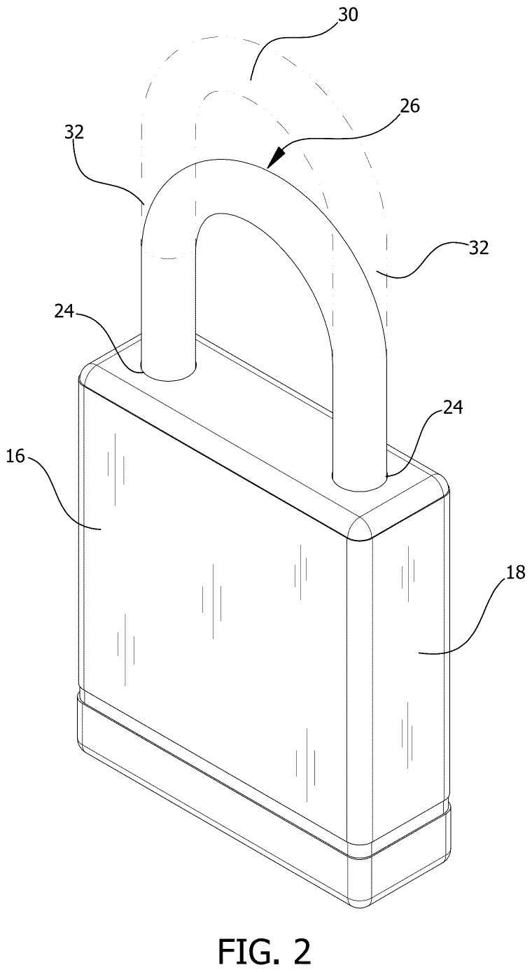

With reference now to the drawings, and in particular to FIGS. 1 through 5 thereof, a new padlock embodying the principles and concepts of an embodiment of the disclosure and generally designated by the reference numeral 10 will be described.

As best illustrated in FIGS. 1 through 5, the high visibility padlock device 10 generally comprises a body 12 having a front wall 14, a back wall 16, and a peripheral wall 18 that is coupled to and extends between the front wall 14 and the back wall 16. The peripheral wall 18 may have a top side 20 and a bottom side 22. The body 12 may also include a pair of apertures 24 that extend into the top side 20.

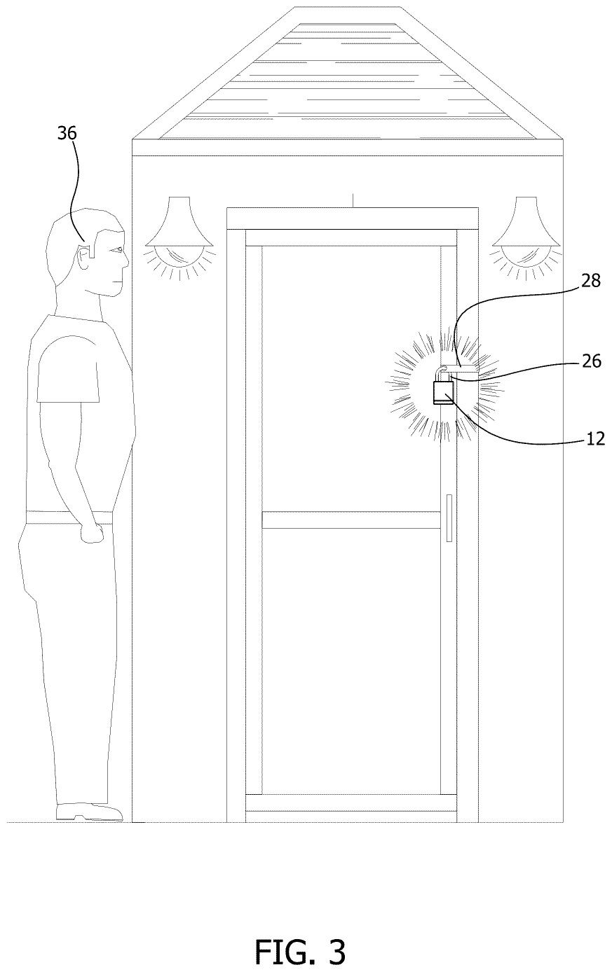

A shackle 26 is coupled to the body 12 wherein the shackle 26 is configured to releasably secure the body 12 to a structure 28. For example, the structure 28 may comprise a staple and hasp mechanism that is coupled to a door of a building, as shown in FIG. 3. In such embodiments, the shackle 26 is typically positionable to extend through the staple and secure the hasp over the staple, thereby securing the door in a closed position. The shackle 26 may be positioned on the top side 20 of the body 12. The shackle 26 may include an arcuate member 30 and a pair of legs 32 that are coupled to and extend from opposing ends of the arcuate member 30. Each leg of the pair of legs 32 is generally positioned within a respective aperture of the pair of apertures 24 while the shackle 26 releasably secures the body 12 to the structure 28. In other words, each leg of the pair of legs 32 is generally positioned within, or positionable within, the respective aperture of the pair of apertures 24. The pair of legs 32 may be parallel to each other.

An indicium 34 is positioned on the body 12. The indicium 34 is a high visibility color wherein the indicium 34 is configured to increase visibility of the body 12 to a user 36. For example, the high visibility color may include florescent colors, neon colors, bright red, orange, pearl white, blue, yellow, purple, and other bright, highly visible colors. The high visibility color may also include shades that are not typically found in nature such that the indicium 34 is configured to increase visibility of the body 12 to the user 36 when the body 12 is dropped on the ground. Such embodiments may be particularly useful when the structure 28 is positioned in areas with significant vegetative growth or on gravel, where the traditional silver and bronze shades used for padlocks blend in.

The high visibility color is also generally reflective wherein the indicium 34 is configured to reflect light to increase visibility of the body 12 to the user 36. For example, as indicated by FIG. 3, the high visibility color may reflect light from lamps or other lights which are attached to the structure 28 or the building. In another example, the high visibility color may reflect light that is shone by a flashlight, which may be particularly useful when the user 36 has dropped the body 12 on the ground in the dark or when the body 12 is dropped into water. In yet another example, the high visibility color may reflect sunlight, which may be particularly useful when the body 12 is dropped in snow.

The indicium 34 is generally positioned on the front wall 14 of the body. For example, the indicium 34 may be positioned to fully cover the front wall 14 of the body 12. The indicium 34 may also be positioned on the back wall 16 of the body 12. In some embodiments, the indicium 34 may be positioned to fully cover the back wall 16 of the body 12. The indicium 34 may also be positioned on the peripheral wall 18 and may even fully cover the peripheral wall 18 of the body 12.

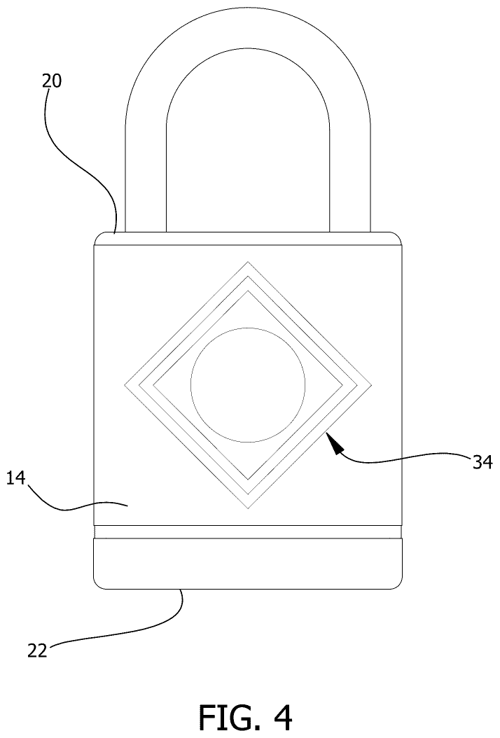

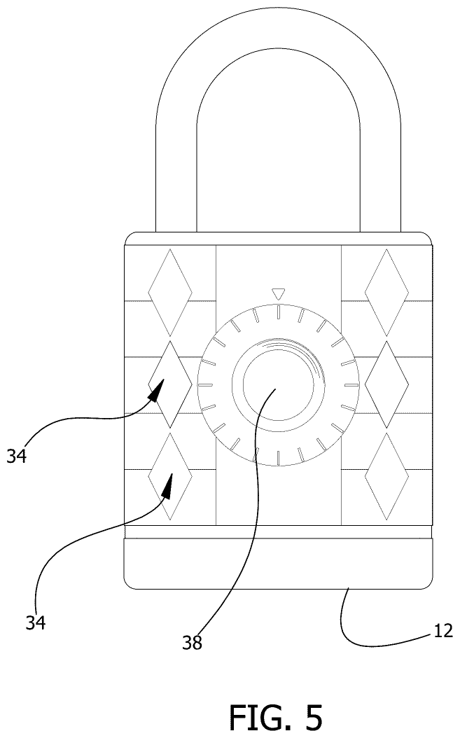

The indicium 34 may include a pattern. FIGS. 4 and 5 depict examples of the indicium 34 being the pattern, which generally includes geometric shapes and decorative lines. Other patterns, such as animal figures, letters, emoticons, emojis, characters, and other images are also contemplated. The pattern may vary from embodiment to embodiment, for example to facilitate a user 36 in distinguishing between embodiments, particularly from a distance. The indicium 34 may also include a solid color. FIGS. 1-3 depict examples of the indicium 34 being the solid color.

The indicium 34 may be covered by a clear coating that is configured to inhibit the indicium 34 from damage. More specifically, the body 12 may often be used on boats, sheds, trailers, and in other outdoor situations. Accordingly, the body 12 may be regularly exposed to harsh weather conditions such as rain, snow, heat, and sunlight. The indicium 34 should be able to inhibit corrosion and deterioration when exposed to such harsh weather conditions.

A lock 38 may be coupled to the body 12. The lock 38 generally releasably engages the shackle 26 to secure the body 12 to the structure 28. For example, the lock 38 may engage the shackle 26 when each leg of the pair of legs 32 is positioned within the respective aperture of the pair of apertures 24 and the lock 38 is positioned in a locking condition thereby inhibiting removal of at least one leg of the pair of legs 32 of the shackle 26 from the respective aperture of the pair of apertures 24 of the body 12. The lock 38 may disengaging the shackle 26 when the lock 38 is positioned in an unlocking condition, for example facilitating removal of at least one leg of the pair of legs 32 from the respective aperture of the pair of apertures 24. In other words, the lock 38 may releasably engage the shackle 26 when the lock 38 is in the locking condition wherein the lock 38 is configured to inhibit the shackle 26 from releasing the body 12 from the structure 28. The lock 38 may disengage the shackle 26 when the lock 38 is in the unlocking condition to facilitate removal of the body 12 from the structure 28.

The lock 38 may be a turn-key lock, such as the lock 38 portrayed in FIG. 1. In such embodiments, the lock 38 may be positioned on the bottom side 22 of the peripheral wall 18 of the body 12. In another example, the lock 38 may be a rotating knob, such as the lock 38 portrayed in FIG. 5. In such embodiments, the lock 38 may be positioned on the front side of the peripheral wall 18. Alternative embodiments for the lock 38 are also contemplated.

In use, the shackle 26 can secure the body 12 to the structure 28. The indicium 34 increases visibility of the body 12 to the user 36. When the user 36 is driving or walking up to the structure 28, the high visibility color of the indicium 34 may reflect light to facilitate visibility of the body 12 from a distance. The pattern or the solid color of the indicium 34 may also help the user 36 to identify which structure 28 is theirs. For example, when the structure 28 is a storage unit that is surrounded by other, nearly identical storage units, the pattern or the solid color of the indicium 34 may make the body 12 stand out so that the user 36 can easily discern which of the nearly identical storage units belongs to the user 36.

When the user 36 has removed the body 12 from the structure 28, the high visibility color of the indicium 34 helps the user 36 keep track of the body 12, inhibiting loss of the body 12. For example, when the body 12 is placed, or dropped, on the ground, the indicium 34 can stand out against the ground so that the user 36 can easily locate the body 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lock assembly comprising:
a body;
a shackle being coupled to the body wherein the shackle is configured to releasably secure the body to a structure; and
an indicium being positioned on the body, the indicium being a high visibility color wherein the indicium is configured to increase visibility of the body to a user, the high visibility color being reflective wherein the indicium is configured to reflect light to increase visibility of the body to the user, the indicium being positioned on a front wall of the body.

2. The lock assembly of claim 1, the body further comprising a pair of apertures extending into the top side.

3. The lock assembly of claim 2, the shackle further comprising an arcuate member and a pair of legs being coupled to and extending from opposing ends of the arcuate member wherein each leg of the pair of legs is positioned within a respective aperture of the pair of apertures.

4. The lock assembly of claim 3, further comprising a lock being coupled to the body, the lock releasably engaging the shackle when each leg of the pair of legs is positioned within the respective aperture of the pair of apertures and the lock is positioned in a locking condition thereby inhibiting removal of at least one leg of the pair of legs from the respective aperture of the pair of apertures.

5. The lock assembly of claim 1, further comprising a lock being coupled to the body, the lock releasably engaging the shackle when the lock is in a locking condition wherein the lock is configured to inhibit the shackle from releasing the body from the structure.

6. The lock assembly of claim 1, wherein the indicium is positioned to fully cover the front wall of the body.

7. The lock assembly of claim 6, wherein the indicium is positioned on a back wall of the body.

8. The lock assembly of claim 7, wherein the indicium is positioned to fully cover the back wall of the body.

9. The lock assembly of claim 7, wherein the indicium is positioned on a peripheral wall of the body.

10. The lock assembly of claim 9, wherein the indicium is positioned to fully cover the peripheral wall of the body.

11. The lock assembly of claim 1, the indicium further comprising a pattern.

12. The lock assembly of claim 1, the indicium further comprising a solid color.

13. A lock assembly comprising:
a body having a front wall, a back wall, and a peripheral wall being coupled to and extending between the front wall and the back wall, the peripheral wall having a top side and a bottom side, the body including:
a pair of apertures extending into the top side;
a shackle being coupled to the body wherein the shackle is configured to releasably secure the body to a structure, the shackle including an arcuate member and a pair of legs being coupled to and extending from opposing ends of the arcuate member wherein each leg of the pair of legs is positioned within a respective aperture of the pair of apertures, the pair of legs being parallel to each other;
an indicium being positioned on the body, the indicium being a high visibility color wherein the indicium is configured to increase visibility of the body to a user, the high visibility color being reflective wherein the indicium is configured to reflect light to increase visibility of the body to the user, the indicium being positioned to fully cover the front wall of the body, the indicium being positioned to fully cover the back wall of the body, the indicium being positioned to fully cover the peripheral wall of the body; and
a lock being coupled to the body, the lock releasably engaging the shackle when each leg of the pair of legs is positioned within the respective aperture of the pair of apertures and the lock is positioned in a locking condition thereby inhibiting removal of at least one leg of the pair of legs from the respective aperture of the pair of apertures, the lock disengaging the shackle when the lock is positioned in an unlocking condition thereby facilitating removal of at least one leg of the pair of legs from the respective aperture of the pair of apertures.
